(19) United States
(12) Patent Application Publication
(10) Pub. No.: US 2006/0161818 A1
(43) Pub. Date: Jul. 20, 2006

(54) On-chip hardware debug support units utilizing multiple asynchronous clocks

(76) Inventor: Ivo Tousek, Stockholm (SE)

Correspondence Address: COOPER & DUNHAM, LLP, 1185 AVENUE OF THE AMERICAS, NEW YORK, NY, 10036, US

(21) Appl. No.: 11/036,445

(22) Filed: Jan. 14, 2005

(51) Int. Cl. G06F 11/00

(52) U.S. Cl. 714/45

(57) ABSTRACT

A system for interfacing a debugger, the debugger utilizing a test clock, with a system under debug, the system under debug utilizing one or more system clocks includes a test-clock unit, utilizing the test clock, connected in communication with the debugger, and one or more system-clock units, each of which having a corresponding one of the one or more system clocks, connected in communication with the system under debug and the test-clock unit. The one or more system-clock units utilize their corresponding system clock when communicating with the system under debug and utilize the test clock when communicating with the test-clock unit.

### BACKGROUND

1. Technical Field

The present invention relates to on-chip hardware support units and, more specifically, to on-chip hardware debugging support units utilizing multiple asynchronous clocks.

2. Description of the Related Art

Digital Signal Processing (DSP) relates to the examination and manipulation of digital representations of electronic signals. Digital signals that are processed using digital signal processing are often digital representations of real-world audio and/or video.

Digital signal processors are special-purpose microprocessors that have been optimized for the processing of digital signals. Digital signal processors are generally designed to handle digital signals in real-time, for example, by utilizing a real-time operating system (RTOS). A RTOS is an operating system that may appear to handle multiple tasks simultaneously, for example, as the tasks are received. The RTOS generally prioritizes tasks and allows for the interruption of low-priority tasks by high-priority tasks. The RTOS generally manages memory in a way that minimizes the length of time a unit of memory is locked by one particular task and minimizes the size of the unit of memory that is locked. This allows tasks to be performed asynchronously while minimizing the opportunity for multiple tasks to try to access the same block of memory at the same time.

Digital signal processors are commonly used in embedded systems. An embedded system is a specific-purpose computer that is integrated into a larger device. Embedded systems generally utilize a small-footprint RTOS that has been customized for a particular purpose. Digital signal processing is often implemented using embedded systems comprising a digital signal processor and a RTOS.

Digital signal processors are generally sophisticated devices that may include one or more microprocessors, memory banks and other electronic elements. Along with digital signal processors, embedded systems may contain additional elements such as sub-system processors/accelerators, firmware and/or other microprocessors and integrated circuits.

When designing electronic elements such as embedded systems, digital signal processors and/or additional elements, it is common for the electronic elements, at least in the early stages of development, to function in an unplanned and/or unwanted way due to one or more sources of error (bugs) in the element's design. The process of identifying and removing these bugs from the electronic elements is called debugging.

Debugging can be cumbersome and difficult. This difficulty is in-part caused by the extraordinary complexity of modem electronic elements. Often a bug is observable only by one or more generic problems, such as a malfunction or crash. It can therefore be difficult to determine what problem in the electronic element's design gave rise to the bug.

Debugging electronic elements can be especially difficult as it is very hard to see exactly what has happened inside the electronic element being debugged that caused it to crash or otherwise malfunction. Often times, all that can be observed is the presence of a bug and solutions must be obtained through trial-and-error rather than through deductive reasoning.

To facilitate debugging, a debugger may be used to interface with the electronic element being debugged. A debugger may be a computer system executing one or more debugging applications. A debugger may allow for more detailed interaction with the electronic element being debugged so that a bug may be recognized and corrected.

However it is frequently the case that the debugger and the electronic element being debugged each run according to independent clocks. This can present a problem as digital devices running on independent clocks may not have an efficient means for exchanging of information. Frequently exchanging information between the debugger and the electronic element being debugged requires the use of expensive synchronization hardware, for example, duplicate memory buffers that are capable of copying data from the domain of one clock speed to the domain of another clock speed. Additionally, many systems for exchanging information between the debugger and the electronic element being debugged require that the functional clock of the electronic element being debugged run at a precise ratio to the test clock of the debugger. For example many systems require that the functional clock run at least twice as fast as the test clock. These solutions may be expensive and/or restrictive.

It is therefore desirable to utilize methods and systems for providing on-chip hardware debugging support with reduced hardware implementation cost and free from requirements relating to the ratio of functional clock frequency to test clock frequency.

### SUMMARY

This invention concerns a system for interfacing a debugger utilizing a test clock with a system under debug utilizing one or more system clocks. A test-clock unit utilizing the test clock is connected in communication with the debugger and one or more system-clock units, each of which having a corresponding system clock. The system-clock units are connected in communication with the system under debug and the test-clock unit. The one or more system-clock units utilize their corresponding system clock when communicating with the system under debug and utilize the test clock when communicating with the test-clock unit.

A method for debugging electronic hardware includes supplying one or more system-clock units with one or more corresponding clock signals. The one or more clock signals are equal to a debugger clock when the system-clock units are communicating with a debugger and the one or more clock signals are equal to a corresponding one or more electronic hardware clocks when the system clock units are communicating with the electronic hardware.

A computer system includes a processor and a program storage device readable by the computer system. The computer system embodying a program of instructions executable by the processor to perform method steps for debugging electronic hardware. The method includes supplying one or more system-clock units with one or more corresponding clock signals. The one or more clock signals are equal to a debugger clock when the system-clock units are communicating with a debugger and the one or more clock signals are equal to a corresponding one or more electronic hardware clocks when the system clock units are communicating with the electronic hardware.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram showing an SUD with an on-chip DBG according to one embodiment of the present invention;

FIG. 2 is a block diagram showing an implementation of TAP that may be utilized by embodiments of the present invention for interfacing the debugger with the system-on-chip;

FIG. 3 is a block diagram showing a DBG according to an embodiment of the present invention;

FIG. 4 is a flow chart illustrating how the debugger may access DBG registers according to an embodiment of the present invention;

FIG. 5 is a flow chart illustrating how the debugger may write data to the SUD according to an embodiment of the present invention;

FIG. 6 is a flow chart illustrating how the debugger may read data from the SUD according to an embodiment of the present invention;

FIG. 7 is a flow chart illustrating how the trace buffer may be read by the debugger according to an embodiment of the present invention;

FIG. 8 is a block diagram showing a conceptual CLK_SW circuitry according to an embodiment of the present invention;

FIG. 9 is a block diagram showing CLK_SW circuitry according to another embodiment of the present invention;

FIG. 10 is a block diagram showing TCK activity detection circuitry according to an embodiment of the present invention;

FIG. 11 is a block diagram showing clock-control circuitry according to an embodiment of the present invention; and

FIG. 12 is a block diagram showing an example of a computer system which may implement the method and system of the present invention.

### DETAILED DESCRIPTION

In describing the preferred embodiments of the present invention illustrated in the drawings, specific terminology is employed for sake of clarity. However, the present invention is not intended to be limited to the specific terminology so selected, and it is to be understood that each specific element includes all technical equivalents which operate in a similar manner.

As mentioned above, one of the difficulties of debugging hardware, for example electronic devices such as digital signal processors and related devices, is the lack of ability to observe the inner workings of the electronic devices under test.

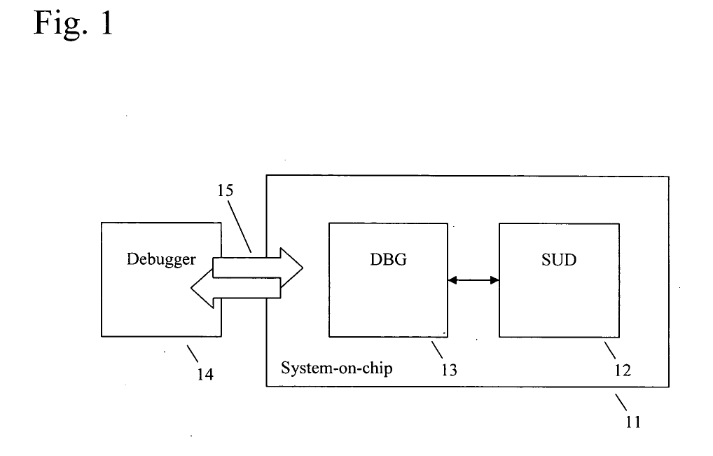

One way in which electronic devices may be debugged is to integrate a hardware debugging unit (DBG) into the electronic system device being debugged (SUD). For example, if the SUD is built onto a microchip, the DBG may be an on-chip debugging unit. FIG. 1 is a block diagram showing an SUD with an on-chip DBG according to one embodiment of the present invention. According to this embodiment, a hardware debug unit (DBG) 13 may be integrated into an integrated device, for example, the circuit element 11 of the electronic device to be tested 12. For example, the DBG 13 may be integrated into a microchip 11 that contains the electronic device to be tested 12. The microchip 11 may be referred to as a system-on-chip. In this context, the electronic device to be tested 12 may be called a system under debug (SUD) 12. Where the DBG 13 is integrated into a microchip, the DBG 13 may be considered an on-chip debug unit. The SUD 12 may then be considered an on-chip system under debug.

The DBG 13 may provide dedicated hardware support to allow an external debugger 14 to debug the SUD 12. The DBG 13 may act as an interface between the SUD 12 and the debugger 14. The DBG 13 may therefore provide a means for the debugger 14 to peer inside the SUD 12 and observe its operation while minimizing the extent to which the processing capacity of the SUD 12 must be utilized to perform testing. This may allow the SUD 12 to function as it would in normal operation, potentially increasing the effectiveness of debugging.

The debugger 14 may be, for example, a computer system that has been configured to facilitate the debugging of the SUD 12. For example, the debugger 14 may be a computer system executing one or more debugging applications.

There are many different forms of debuggers 14 that may be used either individually or in a group of two or more. Different debuggers 14 may support different debugging features. Some examples of debugging features include: system boot, start/stop/resume software execution, setting of program addresses or data breakpoints, reading/writing on-chip memory address locations or registers, software instruction stepping and software execution trace monitoring.

The debugger may interface with the system-on-chip 11 via an external bus 15 that is connected to the DBG 13. The external bus 15 may be able to communicate data and control information between the debugger 14 and the DBG 13. The external bus 15 may conform to one or more interface standards. For example, the external bus 15 may utilize the Joint Test Action Group/Test Access Protocol (JTAG/TAP or TAP) controller interface, for example the JTAG standardized and described in IEEE standard 1149.1, incorporated herein by reference.

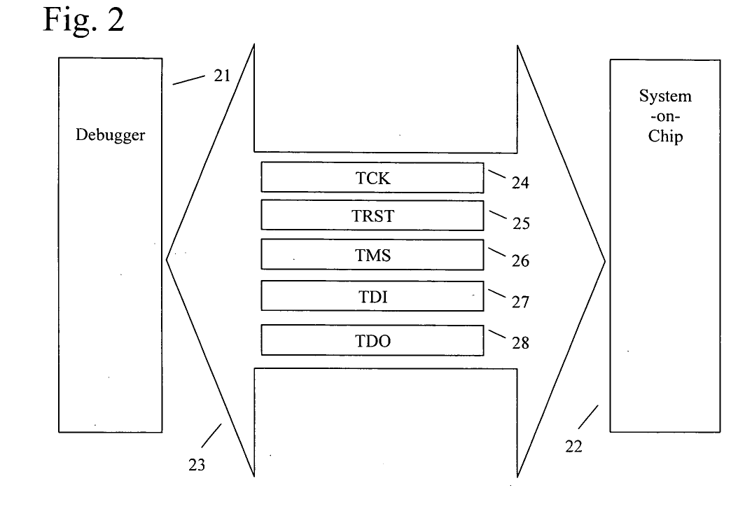

FIG. 2 is a block diagram showing an implementation of TAP that may be utilized by embodiments of the present invention for interfacing the debugger with the system-on-chip. The debugger 21 may be interfaced with the system-on-chip 22 via the TAP 23. The TAP 23 may comprise a test clock signal (TCK) 24 for communicating the test clock frequency from the debugger 21 to the DBG. The TAP 23 may additionally comprise a test reset signal (TRST) 25 to allow the debugger 21 to communicate a reset signal to the DBG. The TAP 23 may additionally comprise a test mode control signal (TMS) 26 to allow the debugger 21 to control its access to the DBG. The TAP 23 may additionally comprise a serial data input signal (TDI) 27 and a serial data output signal (TDO) 28 for the exchange of additional information, for example synchronous information, between the debugger 21 and the DBG.

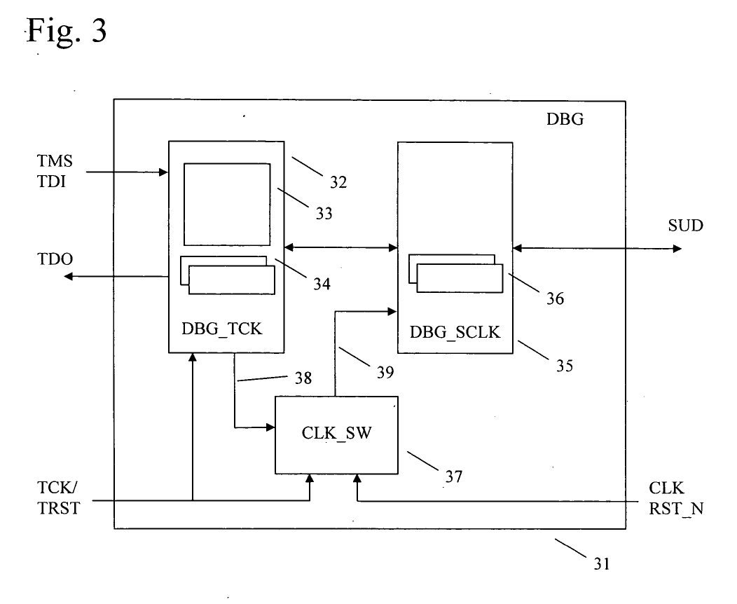

Embodiments of the present invention provide methods and systems for on-chip hardware debugging support by utilizing a DBG that is capable of communicating with a debugger running at a test clock speed and an SUD running at one or more functional clock speeds that may not be synchronous with the test clock speed. FIG. 3 is a block diagram showing a DBG 31 according to an embodiment of the present invention.

The DBG 31 may comprise a DBG test clock interfacing section (DBG_TCK) 32 that interfaces with the external debugger, for example via a TAP interface. The DBG 31 may additionally comprise one or more DBG synchronized clock interfacing sections (DBG_SCLK) 35 that may each interface with a portion of the SUD that runs at a particular clock speed. For example, where the SUD comprises multiple portions, each runs at an independent clock speed, there may be multiple DBG_SCLK sections 35 within the DBG 31, each interfacing with a corresponding section of the SUD. However, for simplicity, embodiments of the present invention may be described in terms of an SUD running at a single clock speed (CLK) and therefore embodiments of the present invention may be shown with a single DBG_SCLK section 35 that may interface with the SUD.

The DBG_TCK 32 may run under the test clock (TCK) as received from the debugger via the TAP. This allows for the efficient communication of data between the debugger and the DBG_TCK. The DBG_TCK 32 may comprise a TAP controller 33 for controlling the flow of information between the DBG and the debugger via the TAP. The DBG_TCK 32 may additionally comprise a set of TCK registers 34.

The TCK registers 34 may comprise a control and status register (T_CSR). The T_CSR may be used for providing asynchronous control debug commands from the debugger to the SUD. For example, debug commands originating from the debugger may be stored in the T_CSR and asynchronously delivered to the SUD after being synchronized to the appropriate CLK.

The SUD may have multiple modes, for example, a functional mode and a debug mode. In the functional mode, the SUD may be permitted to function normally, for example, the SUD may execute applications. In the debug mode, the SUD's execution may be interrupted. For example, the SUD may enter debug mode whenever the SUD comes to a halt due to a debugging event, for example, following an external user stop command or the triggering of a breakpoint, etc.

The SUD may have additional modes, for example, a reset mode and a boot mode. In the reset mode, the SUD is engaged in a system reset. In the boot mode, the SUD may be in transition between the reset mode and the functional mode.

The T_CSR may additionally be used for monitoring a mode status of the SUD. For example, mode status information pertaining to the SUD (a SUD_MODE signal) may be sent from the SUD, synchronized into the TCK clock within the DBG_TCK 32 and then delivered to the T_CSR. The debugger may then stay aware of the SUD status, for example, by periodically interrogating the T_CSR. The debugger may interrogate T_CSR regarless of the SUD mode.

The TCK registers 34 may optionally comprise one or more configuration/data debug registers (T_CDs). The T_CD registers may be used for debugging configuration/control information that is applied to the SUD. The debugger may access the T_CD registers during the debugging mode. The DBG_SCLK and the SUD may utilize information stored in the T_CD registers during functional mode. For example, new breakpoint settings provided by the debugger may be stored in the T_CD data registers and used by the DBG_SCLK in functional mode to trigger a debug stop to the SUD. For example, an SUD instruction may be stored in the T_CD data registers and executed by the SUD in functional mode.

According to some embodiments of the present invention, the T_CSR register may be used to communicate specialized data such as command and status data regardless of the mode of the SUD while the T_CD registers may be used to communicate general data to the SUD. The T_CD registers may be accessed by the debugger while the SUD is in debug mode, reset mode or boot mode. While the SUD is in functional mode, the debugger may not be able to access the T_CD registers.

The DBG 31 may additionally comprise dedicated clock switching circuitry (CLK_SW) 37. The CLK_SW 37 may accept the test clock signal (TCK), for example from the TAP interface. The CLK_SW 37 may also accept the function clock signal (CLK) from the SUD. The CLK_SW 37 may then provide a synchronizing clock signal (S_CLK) 39 that may be either the CLK signal or the TCK signal. The CLK_SW 37 may then receive a clock select signal (TCK_SEL) 38 from the DBG_TCK 32 to determine whether the S_CLK 39 should be set to the TCK or the CLK. For example, the CLK_SW 37 may receive a TCK_SEL 38 with a value of logical 1 when the TCK should be used as the S_CLK and the CLK_SW 37 may recieve a TCK_SEL 38 with a value of logical 0 when the CLK should be used as the S_CLK (receiving a TCK_SEL 38 with a value of logical 1 may be thought of as receiving a TCK_SEL 38 signal and receiving a TCK_SEL 38 with a value of logical 0 may be thought of as not receiving a TCK_SEL 38).

The DBG_SCLK section 35 may be driven by the S_CLK clock signal 39. Hence, the DBG_SCLK section 35 may utilize either the CLK or the TCK as its clock source depending on the TCK_SEL command 38 issued by the DBG_TCK 32.

According to some embodiments of the present invention, debugging information stored within the DBG_SCLK unit 35 may be accessed directly by the debugger and hence the debugging information need not be copied over to other registers within the DBG_TCK 32 to allow for debugger access.

When the DBG_SCLK 35 is utilizing the CLK signal, for example when the SUD is in functional mode, the DBG_SCLK 35 is synchronized with the SUD and hence there is a stable connection between the DBG_SCLK 35 and the SUD. This stable connection may allow for the synchronous transfer of data from the SUD to the DBG_SCLK 35 and/or from the DBG_SCLK 35 to the SUD.

The DBG_SCLK 35 may comprise one or more SCLK registers 36. These SCLK registers 36 may be S_CD configuration/data debug registers. The S_CD registers may be used for sending debugging information provided by the debugger to the SUD. For example, the debugger may send information to the S_CD registers while the SUD is in debug mode and this information may be accessed by the SUD while the SUD is in functional mode. The DBG_SCLK may additionally use the S_CD registers to capture information in run-time from the SUD. For example, the DBG_SCLK may replace information stored in the S_CD registers by the debugger with information from the SUD while the SUD is in functional mode.

When the DBG_SCLK 35 is utilizing the TCK signal, for example when the SUD is in debug mode, the DBG_SCLK 35 is synchronized with the DBG_TCK 32 and the debugger and hence there is a stable connection between the DBG_SCLK 35, the DBG_TCK 32 and the debugger. This stable connection may allow for the synchronous transfer of data between the DBG_SCLK 35 and the debugger. For example the S_CD registers may be accessed by the external debugger.

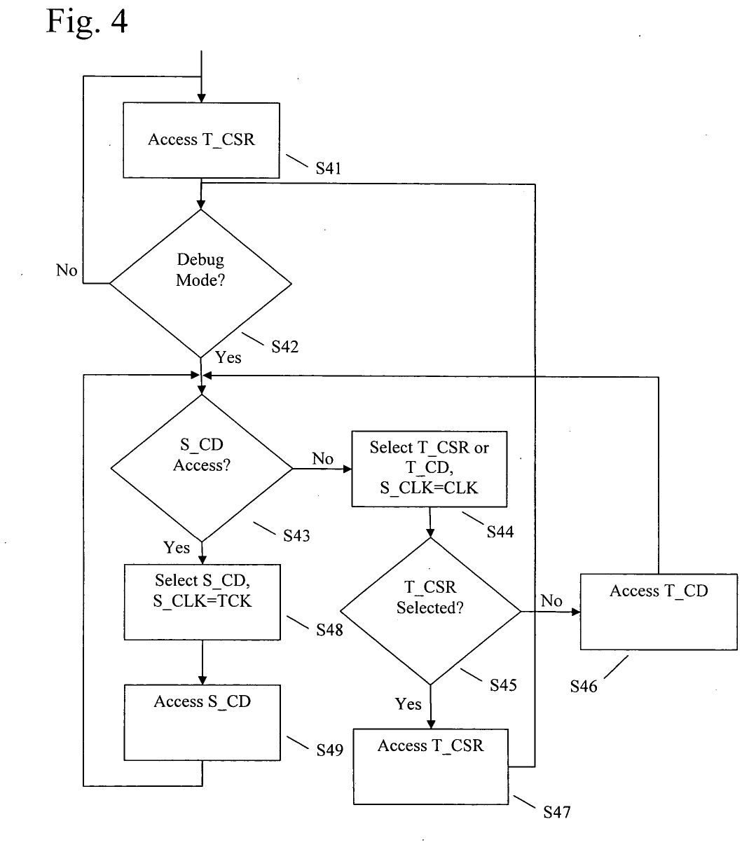

FIG. 4 is a flow chart illustrating how the debugger may access DBG registers according to an embodiment of the present invention. The external debugger may access the T_CSR of the DBG_TCK regardless of the functional mode of the SUD (Step S41). If the SUD is in functional mode and therefore not in debug mode (No, Step S42) then the external debugger may only access the T_CSR (Step S41). If the SUD is in debug mode (Yes, Step S42) then the debugger may initiate access to the T_CD and/or the S_CD by selecting the desired register. Selection may occur by using the JTAG/TAP interface to send an appropriate sequence of TCK, TMS and TDI data. If the debugger seeks to access an S_CD register (Yes, Step S43) then the debugger may select the desired S_CD register and set S_CLK to TCK (Step S48). Then the debugger may access the selected S_CD register (Step S49). If the debugger does not seek to access an S_CD register (No, Step S43) then the debugger may select a T_CD register or the T_CSR register to access and set S_CLK to CLK (Step S44). If the T_CSR register has been selected (Yes, Step S45) then the debugger may access the T_CSR (Step S47). If the T_CSR register has not been selected, hence a T_CD register has been selected (No, Step S45) then the debugger may access the selected T_CD register (Step S46).

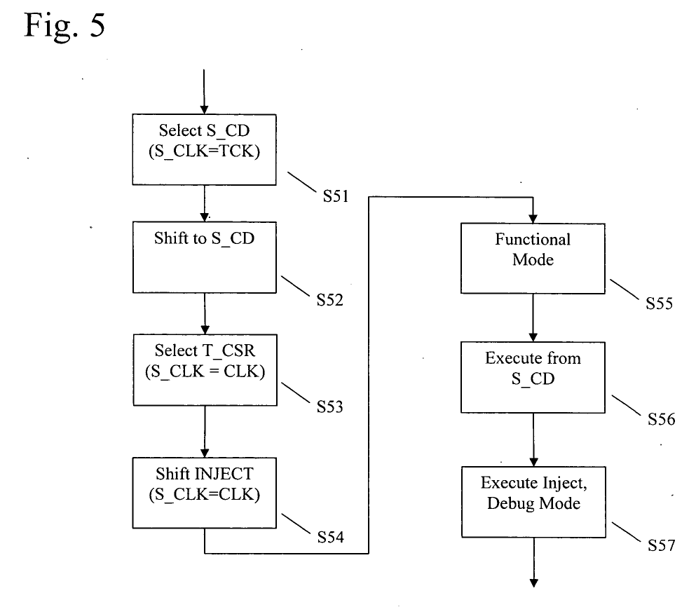

FIG. 5 is a flow chart illustrating how the debugger may write data to the SUD according to an embodiment of the present invention. The debugger may select an S_CD register to access and set S_CLK to TCK (Step S51). The debugger may then shift a data value and an instruction to move data into the selected S_CD register (Step S52). The debugger may then select the T_CSR register and set S_CLK to CLK (Step S53). The debugger may shift an INJECT command into the SUD (Step S54). The INJECT command may be synchronized to the CLK inside DBG_SCLK prior to being received by the SUD. The SUD may then enter functional mode (Step S55). The SUD may execute the data move instruction from the S_CD which sends the data value from the S_CD to its destination within the SUD (Step S56). The SUD may reenter debug mode following the execution of the INJECT command (Step S57).

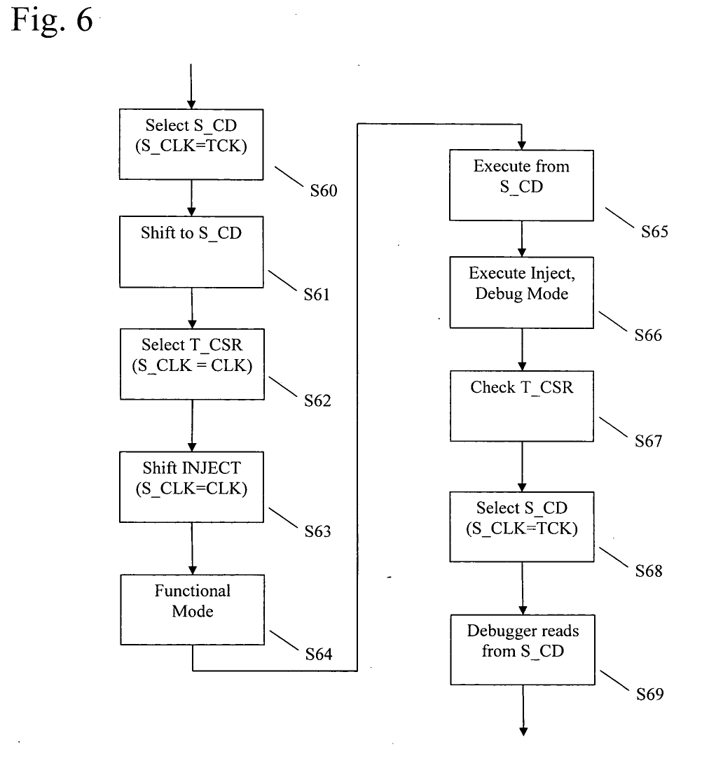

FIG. 6 is a flow chart illustrating how the debugger may read data from the SUD according to an embodiment of the present invention. The debugger may select an S_CD register to access and set S_CLK to TCK (Step S60). The debugger may then shift a data move instruction into the selected S_CD register (Step S61). The debugger may then select the T_CSR register and set S_CLK to CLK (Step S62). The debugger may shift an INJECT command into the SUD (Step S63). The INJECT command may be synchronized to the CLK inside DBG_SCLK prior to being received by the SUD. The SUD may then enter functional mode (Step S64). The SUD may execute the data move instruction from the S_CD which reads data from within the SUD and sends it to an S_CD register (Step S65). The SUD may reenter debug mode following the execution of the INJECT command (Step S66). The debugger may recognize that the SUD has reentered debug mode by checking the SUD mode from the T_CSR (Step S67). The debugger may then select the S_CD register that holds the read data and set the S_CLK to TCK (Step S68). The debugger may then read the data from the selected S_CD register (Step S69).

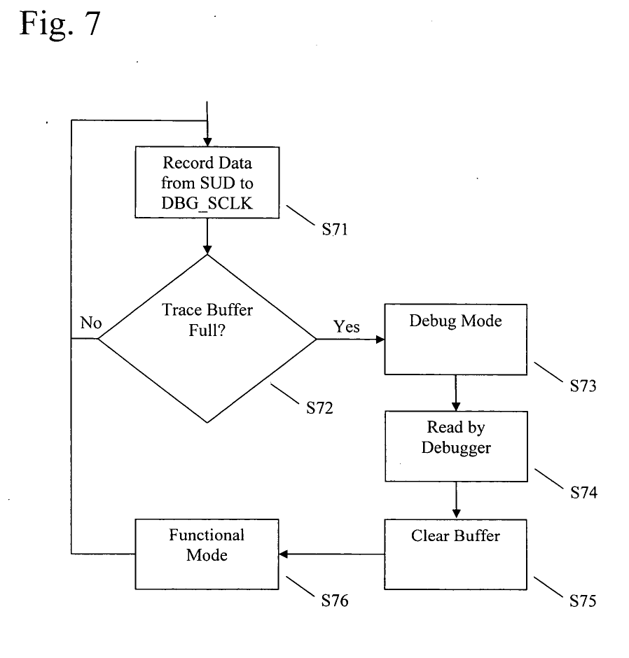

While the SUD is executing in functional mode, it may be desirable to store a trace buffer to collect valuable information pertaining to the SUD's exaction. This information may be utilized by the debugger to aid debugging. For example, the trace buffer may store jump source program address locations for each jump instruction issued by the SUD, for example a DSP. Jump instructions may include branch instructions, call instruction, return instructions, etc. FIG. 7 is a flow chart illustrating how the trace buffer may be read by the debugger according to an embodiment of the present invention. While the SUD is in functional mode, trace buffer information may be recorded from the SUD to the trace buffer within the DBG_SCLK registers (Step S71). The trace buffer loop shown in FIG. 7 may be repeated for as long as the SUD continues to execute. For as long as the trace buffer is not full (No, Step S72), data may continue to be recorded to the trace buffer (Step S71). When the trace buffer is full (Yes, Step S72), the SUD may temporarily enter debug mode (Step S73). The trace buffer may then be read by the debugger (Step S74). For example, the trace buffer may be shifted to the debugger. The trace buffer may then be cleared (Step S75). The SUD may then reenter functional mode (Step S76) and continue with SUD execution and recording of the trace buffer data (Step S71).

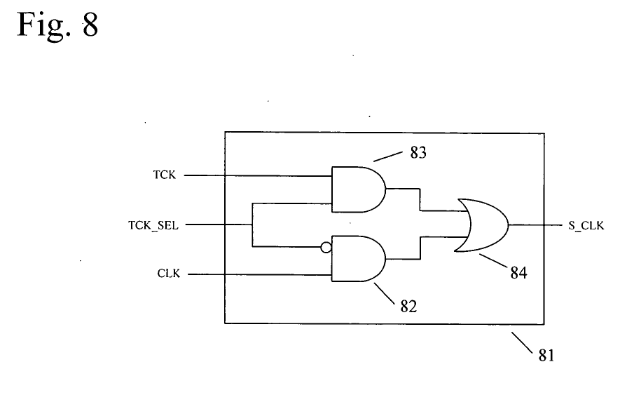

As described above, the CLK_SW may allow for the switching of S_CLK between CLK and TCK. FIG. 8 is a block diagram showing a conceptual CLK_SW circuitry according to an embodiment of the present invention. This conceptual CLK_SW may be used to describe the logic that forms the basis of a CLK_SW circuitry. The CLK_SW circuitry 81 may receive as input, the test clock (TCK), the functional clock (CLK) and the test clock select signal (TCK_SEL). When the TCK_SEL is set at a logical 1, the “AND” gate 82 receives a logical zero as its first input and receives the CLK as its second input. The output of the “AND” gate 82 will therefore be a stable logical zero. When the TCK_SEL is set at a logical 1, the “AND” gate 83 receives the TCK as its first input and a logical 1 as its second input. The output of the “AND” gate 83 will therefore be a logical 1 at each TCK strobe. Therefore, the output of the “AND” gate 83 will be TCK. The “OR” gate 84 will therefore receive the TCK as its first input and a stable logical zero as its second input. The output of the “OR” gate 84 will therefore be a logical 1 at each TCK strobe. Therefore, the output of the “OR” gate 84 will be TCK.

Alternatively, when the TCK_SEL is set at a logical 0, the “AND” gate 82 receives a logical 1 as its first input and receives the CLK as its second input. The output of the “AND” gate 82 will therefore be the CLK. When the TCK_SEL is set at a logical 0, the “AND” gate 83 receives the TCK as its first input and a logical 0 as its second input. The output of the “AND” gate 83 will therefore be a stable logical 0. The “OR” gate 84 will therefore receive a logical 0 as its first input and CLK as its second input. The output of the “OR” gate 84 will therefore be a logical 1 at each CLK strobe. Therefore, the output of the “OR” gate 84 will be CLK.

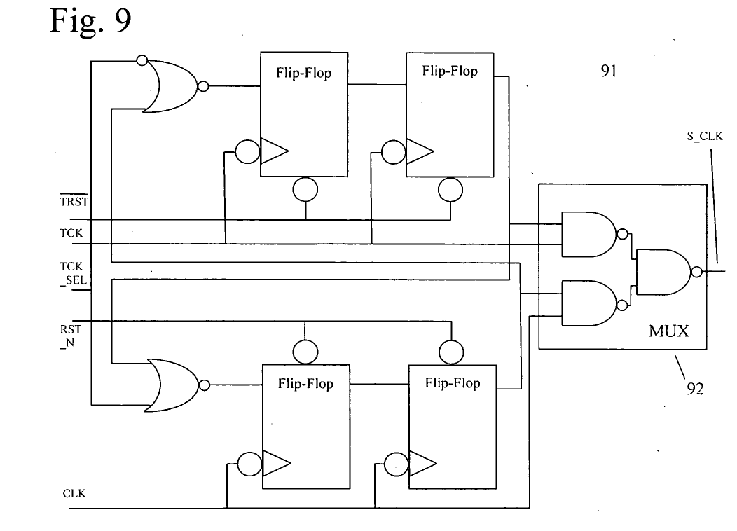

FIG. 9 is a block diagram showing CLK_SW circuitry according to another embodiment of the present invention. The MUX structure 92 comprising “NAND” gates is structurally equivalent to the CLK_SW circuitry shown in FIG. 8. However, the CLK_SW structure 91 of FIG. 9 may provide clean glitch-free switching between CLK and TCK, even when the TCK_SEL signal is asynchronous with respect to either or both the CLK and the TCK. When both resets (RST_N and TRST) are active, the CLK will be driven to the S_CLK output. The DBG_TCK unit may drive the TCK_SEL signal inactive when TRST is active (active low). The TCK_SEL signal may be driven active (high) if any of the S_CD registers are selected for access by the debugger. Hence, when the debugger prepares to access and/or during the access of any of the S_CD registers, TCK_SEL is driven active (high) which may cause the CLK_SW circuitry to drive the TCK root clock as its output. Otherwise, the CLK_SW circuitry drives the CLK root clock as its output. Hence, the DBG_SCLK unit may operate in synchronization with the SUD (using the CLK clock) when the SUD is in functional mode. While the SUD is in debug mode or in boot mode, and/or when accessed by the debugger, the DBG_SCLK unit may operate in synchronization with the TCK test clock.

The CLK_SW circuitry shown in FIG. 9 utilizes two set flip-flops connected in series (dual-flop synchronizers) for each clock signal (CLK and TCK). These dual-flop synchronizers prevents instability/meta-stability that may be caused when signals change state too close to the edges of the clock functions.

After the SUD is fully debugged and/or ready for production, the DBG unit may be deactivated to conserve power during the desired operation of the SUD, for example, once it is integrated into a digital signal processor system. The DBG_TCK according to embodiments of the present invention may be easily disabled, for example by keeping TRST active low and TCK equal to zero. Similarly, the DBG_SCLK can be disabled by global-clock gating. For example, the DBG_TCK may incorporate TCK activity detection circuitry.

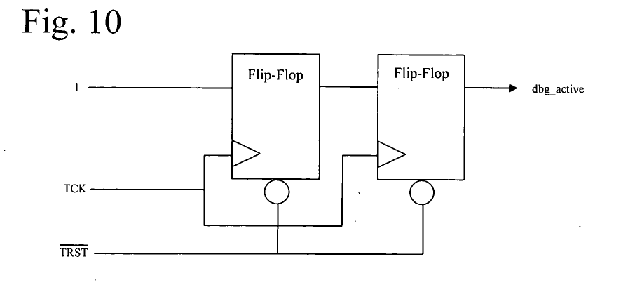

FIG. 10 is a block diagram showing TCK activity detection circuitry according to an embodiment of the present invention. Here, when the debugger is not connected (/TRST and TCK are both tied off and inactive) the DBG_TCK unit is held in reset by the active /TRST test reset and the DBG_SCLK unit keeps its reset state following the release of the functional reset RST_N when it does not detect a clock on S_CLK.

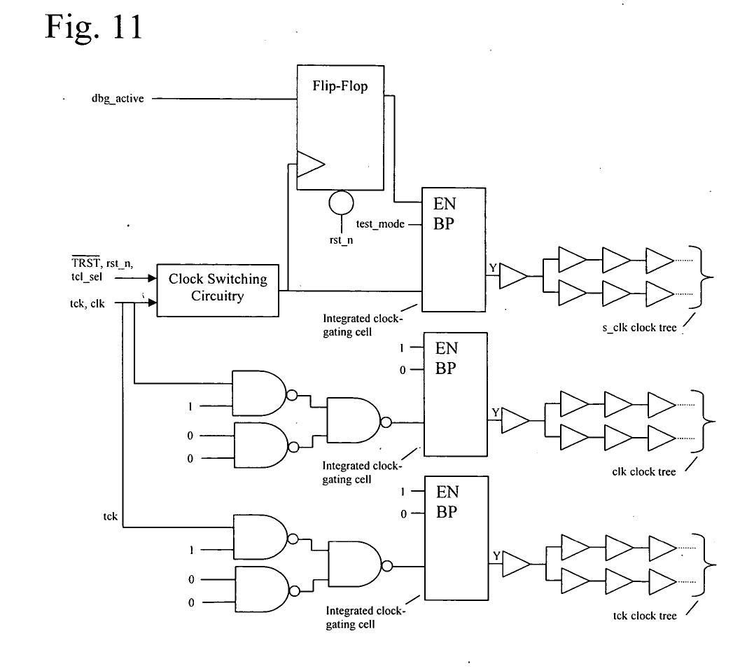

The TCK activity detection circuitry may control a global clock-gating cell in clock control circuitry responsible for providing the clock to the DBG_SCLK unit. FIG. 11 is a block diagram showing clock-control circuitry according to an embodiment of the present invention. This circuitry may utilize the TCK and CLK root clocks and drive the TCK, S_CLK and CLK clock trees in the system.

The activity detection circuitry shown in FIG. 10 may be used to control the top-most integrated clock-gating cell of the clock-control circuitry shown in FIG. 11.

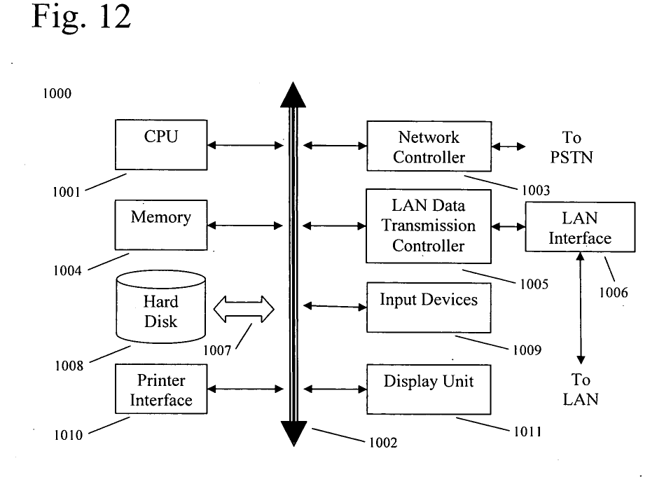

FIG. 12 is a block diagram showing an example of a computer system which may implement the method and system of the present invention. The system and method of the present invention may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the invention or from the scope of the appended claims. For example, elements and/or features of different illustrative embodiments may be combined with each other and/or substituted for each other within the scope of this invention and appended claims.

What is claimed is:

1. A system for interfacing a debugger, the debugger utilizing a test clock, with a system under debug, the system under debug utilizing one or more system clocks, comprising:
a test-clock unit, utilizing the test clock, connected in communication with the debugger; and
one or more system-clock units, each of which having a corresponding one of the one or more system clocks, connected in communication with the system under debug and the test-clock unit,
wherein the one or more system-clock units utilize their corresponding system clock when communicating with the system under debug and utilize the test clock when communicating with the test-clock unit.

2. The system of claim 1, wherein each of the one or more system-clock units is connected in communication with the debugger, wherein the one or more system-clock units utilize their corresponding system clock when communicating with the system under debug and utilize the test clock when communicating with the debugger.

3. The system of claim 1, additionally comprising one or more clock-switching units, one of which corresponds to each of the one or more system-clock units, the one or more clock-switching units being connected in communication with the test-clock unit and the system-clock unit corresponding to the clock-switching unit, wherein each of the one or more clock-switching units sends a clocking signal to its corresponding system-clock unit such that the clocking signal equals the test clock when the system-clock unit is communicating with the test-clock unit and the clocking signal equals the clock-switching unit's corresponding system clock when the system-clock unit is communicating with the system under debug.

4. The system of claim 1, wherein the system under debug is a digital signal processor.

5. The system of claim 1, wherein the system under debug, the test-clock unit and the system-clock unit are incorporated into an integrated device or a microchip.

6. A method for debugging electronic hardware comprising:
supplying one or more system-clock units with one or more corresponding clock signals, wherein the one or more clock signals are equal to a debugger clock when the system-clock units are communicating with a debugger and the one or more clock signals are equal to a corresponding one or more electronic hardware clocks when the system clock units are communicating with the electronic hardware.

7. The method of claim 6, wherein the debugger is a hardware debugging unit that is in communication with a computer executing a debugging application.

8. The method of claim 6, wherein the debugger is a computer executing a debugging application.

9. The method of claim 6, wherein a clock-switching unit sets the one or more clock signals equal to a debugger clock when the system-clock units are communicating with a debugger and sets the one or more clock signals equal to the corresponding one or more electronic hardware clocks when the system clock units are communicating with the electronic hardware.

10. The method of claim 9, wherein the debugger is a hardware debugging unit that is in communication with a computer executing a debugging application.

11. The method of claim 9, wherein the debugger is a computer executing a debugging application.

12. The method of claim 9, wherein the clock-switching unit sets the one or more clock signals based on an instruction sent to the clock-switching unit from the debugger or the hardware debugging unit.

13. A computer system comprising:
a processor; and
a program storage device readable by the computer system, embodying a program of instructions executable by the processor to perform steps for debugging electronic hardware, the steps comprising:
supplying one or more system-clock units with one or more corresponding clock signals, wherein the one or more clock signals are equal to a debugger clock when the system-clock units are communicating with a debugger and the one or more clock signals are equal to a corresponding one or more electronic hardware clocks when the system clock units are communicating with the electronic hardware.

14. The computer system of claim 13, wherein the debugger is a hardware debugging unit that is in communication with a computer executing a debugging application.

15. The computer system of claim 13, wherein the debugger is a computer executing a debugging application.

16. The computer system of claim 13, wherein a clock-switching unit sets the one or more clock signals equal to a debugger clock when the system-clock units are communicating with a debugger and sets the one or more clock signals equal to the corresponding one or more electronic hardware clocks when the system clock units are communicating with the electronic hardware.

17. The computer system of claim 16 wherein the debugger is a hardware debugging unit that is in communication with a computer executing a debugging application.

18. The computer system of claim 16 wherein the debugger is a computer executing a debugging application.

19. The computer system of claim 16, wherein the clock-switching unit sets the one or more clock signals based on an instruction sent to the clock-switching unit from the debugger.

20. The computer system of claim 17, wherein the clock-switching unit sets the one or more clock signals based on an instruction sent to the clock-switching unit from the hardware debugging unit.
